(19) United States
(12) Patent Application Publication
(10) Pub. No.: US 2007/0078975 A1
(43) Pub. Date: Apr. 5, 2007

(54) System For Monitoring Cable Interface Connections In A Network

(76) Inventors: Charles R. LeMay, Portsmouth, NH (US); Clifford Risher-Kelly, Well, ME (US); Martin Doering, Watertown, MA (US)

Correspondence Address: JACK SCHWARTZ & ASSOCIATES, 1350 BROADWAY, SUITE 1510, NEW YORK, NY, 10018, US

(21) Appl. No.: 11/531,169

(22) Filed: Sep. 12, 2006

Related U.S. Application Data
(60) Provisional application No. 60/716,794, filed on Sep. 13, 2005.

(51) Int. Cl. G06F 15/173

(52) U.S. Cl. 709/224

(57) ABSTRACT

A system monitors cable interface connections in a network. An individual cable interface connection includes a connection between a cable and an associated device in the network. The monitoring system includes a plurality of individual interface controllers for monitoring an associated plurality of individual cable interface connections. The plurality of individual interface controllers include a first interface controller for automatically, acquiring device type identification data from a second interface controller monitoring a connection between a cable and an associated device in the network. The device type identification data is acquired via the cable and the first and second cable interface connections at the ends of the cable. The device type identification data supports identification of the device associated with the second cable interface connection. The first interface controller further automatically compiles a map including data indicating devices in the network and associated device type identifiers.

### CROSS-REFERENCED TO RELATED APPLICATIONS

This is a non-provisional application of U.S. Provisional Application Ser. No. 60/716,794 filed Sep. 13, 2005.

### FIELD OF THE INVENTION

The present invention relates generally to the field of data processing, and more particularly to the field of network interconnectivity and monitoring.

### BACKGROUND OF THE INVENTION

In network based control and monitoring systems, particular problems arise in the permanent or temporary addition of devices to the network. For example, existing networking systems employ a plethora of cabling and typically require the manual entry of system configurations via switches, software, and jumpers in order to configure interconnected medical devices. These systems are complex and burdensome for end users to manage and are inherently difficult to configure. This, in turn, leads to the possibility of errors in configuring a network system. In medical systems the possibility of errors is particularly to be avoided. A system according to invention principles addresses these deficiencies and related problems.

### BRIEF SUMMARY OF THE INVENTION

In accordance with principles of the present invention, a system monitors cable interface connections in a network. An individual cable interface connection includes a connection between a cable and an associated device in the network. The monitoring system includes a plurality of individual interface controllers for monitoring an associated plurality of cable interface connections. The plurality of individual interface controllers include a first interface controller for automatically acquiring device type identification data from a second interface controller monitoring a connection between a cable and an associated device in the network. The device type identification data is acquired via the cable and the first and second cable interface connections at the ends of the cable. The device type identification data supports identification of the device associated with the second cable interface connection. The first interface controller further automatically compiles a map including data indicating devices in the network and associated device type identifiers.

### BRIEF DESCRIPTION OF THE DRAWING

In the drawing:

FIG. 1 is a diagram of a network including a plurality of nodes with corresponding node interface controllers coupled via system cables according to the principles of the present invention;

FIG. 2 is a diagram of a single node interface controller, according to principles of the present invention, as illustrated in FIG. 1;

FIG. 3 is a schematic diagram of the dock signal interface, according to principles of the present invention, as illustrated in FIG. 2; and

FIG. 4 is an illustration of the system cable plug and socket, according to principles of the present invention, as illustrated in FIG. 2.

### DETAILED DESCRIPTION OF THE INVENTION

A processor, as used herein, operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application, as used herein, comprises code or machine readable instructions for conditioning the processor to implement predetermined functions, such as those of an operating system, cable interface monitoring system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

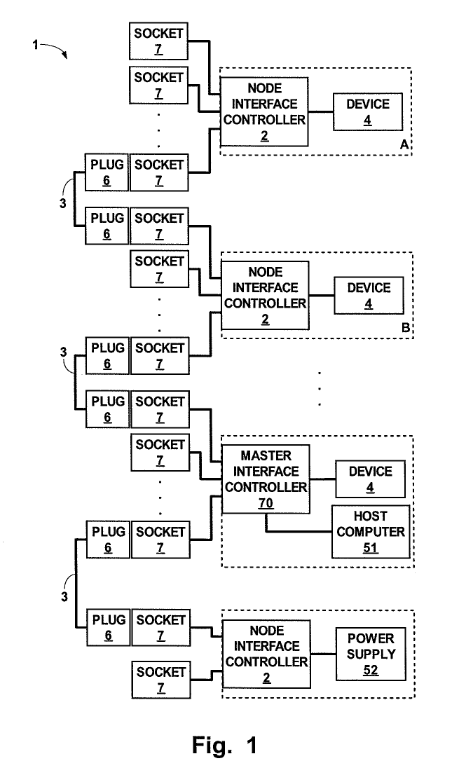

FIG. 1 illustrates a system for monitoring cable interface connections in a network 1. An individual cable interface connection is a connection between a system cable 3 and an associated device 4 in the network. FIG. 1 illustrates a plurality of individual interface controllers 2, 70. These interface controllers 2, 70 monitor an associated plurality of cable interface connections in the network 1. The interface controllers 2, 70 include a first interface controller 70 which can automatically acquire device 4 type identification data from a second interface controller 2 monitoring a connection between the cable 3 and an associated device 4 in the network 1, in a manner to be described in more detail below. The device type identification data is acquired via the cable 3 and the first and second cable interface connections at the ends of the cable 3. The device type identification data supports identification of the device 4 associated with the second cable interface connection 2.

Referring to FIG. 1, a data and power distribution network 1 is depicted which includes a plurality of node interface controllers 2, 70 that permit the interconnection of various associated devices 4, such as medical devices, to a network system cable 3. The node interface controllers 2, 70, are connected to a plurality of system cable sockets 7, which are connectable to corresponding system cable plugs 6. In one embodiment, a node interface controller 2 may be connected to four system cable sockets 7, although one skilled in the art understands that in general the node interface controller 2, 70 may be connected to two or more system cable sockets 7. The node interface controllers 2, 70, may be physically integrated with the associated device 4 in the same enclosure including the system cable sockets 7, as illustrated in node A and node B of FIG. 1. In the illustrated embodiment, the system cable sockets 7 are identical.

A system cable 3 includes a first and second system cable plug 6 connected to respective ends of a cable carrying a plurality of signal conductors. The system cables 3 are constructed identically. In the case of signal conductors carrying communications signals from a transmitter to a receiver and vice versa, the conductors are crossed-over within the cable so that the transmitter in one node interface controller 2 is connected to the receiver in the other node interface controller 2 and visa versa. The system cable plugs 6 are fabricated to plug into the respective system cable sockets 7 as described above. A plurality of system cables 3 may be used to interconnect node interface controllers 2, 70 and their associated devices 4 in the network 1.

A network power supply 52 is also includes a node interface controller 2. In FIG. 1, the node interface controller 2 of the network power supply 52 is connected to two system cable sockets 7. One skilled in the art understands that the network power supply 52 includes a connection to power system mains, a power supply circuit, battery backup and other associated circuitry and equipment (not shown) to maintain power for the network 1. In the illustrated embodiment, the network power supply 52 provides a 24 volt supply voltage.

Nodes may be interconnected in a star configuration, where a plurality of nodes are connected to a central node. This is illustrated in FIG. 1 in which nodes B and the network power supply 52 node are both connected to the master interface controller 70 node by respective system cables 3. Nodes may also be interconnected in a daisy-chain configuration in which nodes are connected in a serial fashion. This is illustrated in FIG. 1 in which the master interface controller 70 node is connected to the node B, and the node B is connected to the node A. One skilled in the art understands that either or both of these network configurations may be used to interconnect nodes in the network 1.

In general, the network 1 further includes a host computer 51 which provides overall command and control of the network 1. A first node interface controller, designated the master interface controller 70, includes a dedicated communications link to a host computer 51. As described above, the master interface controller 70 may be integrated in the same enclosure with the host computer 51. System cable sockets 7 may be made available on this enclosure to which system cable plugs 6 may be connected. The first interface controller, e.g. master interface controller 70, monitors the plurality of cable interface connections in the network. That is, the first interface controller 70 operates as a master interface controller in a manner to be described in more detail below. The master interface controller 70 may include an associated device 4 and interconnect of the associated device 4 to the system cable 3. or may operate as an independent node with no device 4 attached.

Respective node interface controllers 2 pass power and data signals through the system cables 3 via a system cable plugs 6 and system cable sockets 7. A typical data signal transmitted through a node interface controller 2 is a patient monitoring signal such as an alarm signal or a patient vital sign. The node controllers 2 may also transmit data signals via system cable 3 in accordance with standard data transmission protocols and are capable of determining the type of device 4 to which it is connected. The cable 3 will typically serve as the conduit for pulsed or digitized signals in which signal levels are identified by the node interface controller 2 as data representing node addresses and other relevant parameters. A particular node interface controller 2 is typically programmed to recognize data transmitted over cable 3 and to execute specific interface controller functions in response to the received data. The node interface controller 2 determines when and if the node interface controller 2 is attached properly to both the system cable 3 and a particular medical device 4 in order to intelligently control power switching and establish data communications.

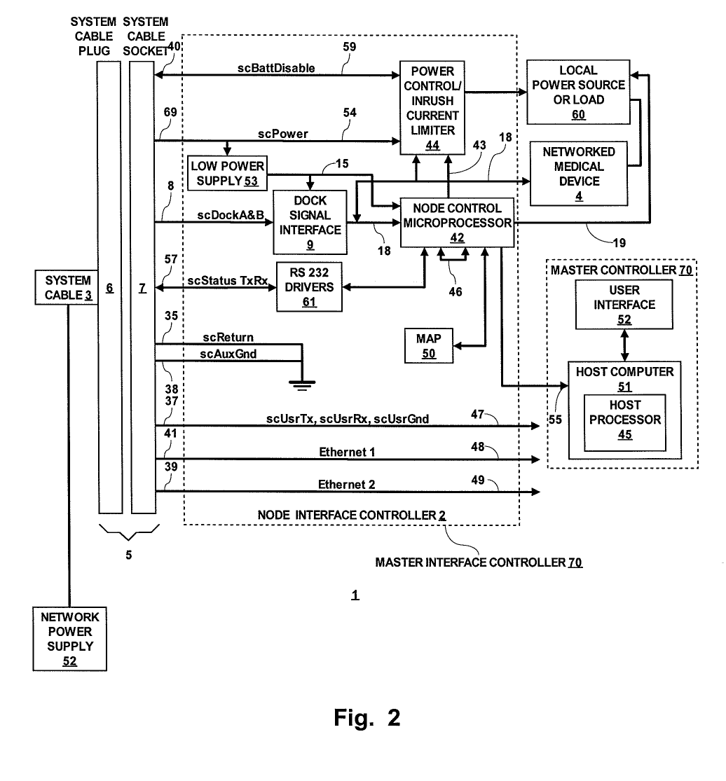

In FIG. 2, the basic elements of a representative interface controller 2 can be appreciated. A system connector 5 is formed to include a system cable socket 7 and a system cable plug 6. The network system cable 3 terminates at the cable plug 6 which is adapted to electrically interconnect the conductors of cable 3 to the cable socket 7. In one embodiment of the present invention, the cable socket 7 includes at least nine system cable conductors or paths which link the cable 3 to the interface controller 2. Specifically, a conductor 8, carrying docking signals scDockA and scDockB, is interconnected to the dock signal interface 9. The system cable 3 conductor 8 provides the docking signals to the dock signal interface 9. The dock signal interface 9 produces a logical output signal 18 that indicates that the system cable 3 is physically and electrically connected to the node interface controller 2 and to a corresponding second node interface controller 2 (not shown) at the other end of the system cable 3. That is, when the system cable 3 is not properly connected to the node interface connector 2, or to the second node interface controller 2 (not shown), the logical output signal 18 has a logical 0 value. When the system cable 3 is properly connected to the node interface connector 2, and to the second node interface controller 2 (not shown), the logical output signal 18 has a logical 1 value. This signal may be used to verity proper connection to the system cable 3 prior to attempting any data transfer between the network 1 and medical device 4.

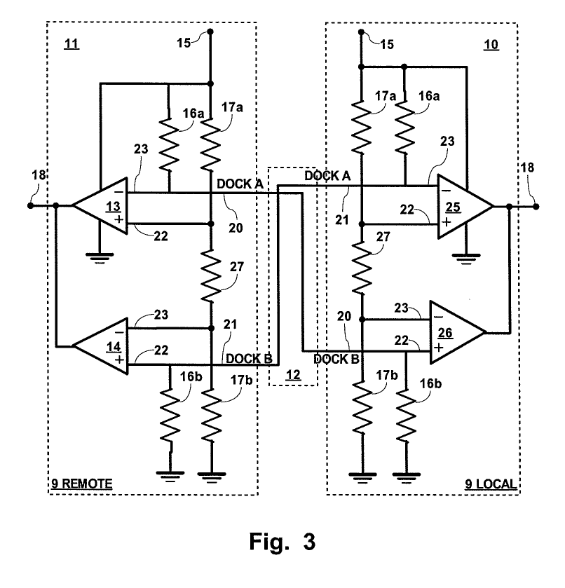

Referring to FIG. 3, the dock signal interface (9 LOCAL) in the node interface controller 2 illustrated in FIG. 2, and a dock signal interface (9 REMOTE) in a corresponding node interface controller 2 (not shown) connected to the other end of the system cable 3 include substantially identical circuits 10 and 11, respectively. The interconnection of the circuit 10 and the circuit 11 via the system cable 3 is illustrated by a cross-over path 12. The circuit 10 processes the signals appearing on the cross-over path 12 in the system cable 3 and includes a pair of comparators 25 and 26. Circuit 11 similarly processes the signals appearing on the cross-over path 12 of the system cable 3 and includes a pair of comparators 13 and 14. The comparators 13, 14, 25, and 26 are LP339W quad comparators manufactured by the National Semiconductor Corporation, 2900 Semiconductor Drive, Santa Clara, Calif. 95052-8090, for example.

Respective nodes 15 are coupled to a voltage supply, which in the illustrated embodiment is a 24 volt supply. Respective voltage dividers in circuits 10 and 11 are formed by the series connection of resistors 17a, 27 and 17b between the supply voltage 15 and a source of reference potential (ground). In the illustrated embodiment, the values of the resistors 17a and 17b are 33 kilohms and the values of the resistors 27 are 100 kilohms. The voltage at the junction of resistors 17a and 27, therefore, is substantially 19 volts and the voltage at the junction of resistors 27 and 17b is substantially 5 volts. Respective resistors 16a are coupled between the voltage supply terminal 15 and the inverting input terminals of the comparators 13 and 25, and respective resistors 16b are coupled between ground and the non-inverting input terminals of the comparators 14 and 26. In the illustrated embodiment, the values of the resistors 16a and 16b are 100 kilohms.

In operation, the circuits 10 and 11 operate as a detector for generating a connection signal in response to detecting that the first and second ends of the cable are electrically connected to corresponding first and second connectors of first and second cable interface connections, in a manner described in more detail below. The detector generates the connection signal in response to detection of a valid electrical connection through the cable between the first and second circuits associated with the respective first and second cable interface connections.

More specifically, the circuits 10 and 11 perform the function of verifying the proper interconnection of the respective node interface controllers 2 with the system cable 3. In FIG. 3, the operation of the comparators 13, 14, 25 and 26 is: when the voltage at the non-inverting input terminal 22 is larger than the voltage at the inverting input terminal 23, the value of the signal at output terminal is a logical 1 signal. When the voltage at non-inverting input terminal 22 is smaller than the voltage at the inverting input terminal 23, the value of the output signal at output terminal is a logical 0 signal. The outputs of the comparators 13 and 14, and of comparators 25 and 26, are wire-ORed, meaning that both comparators must produce a logical 1 signal before the output signal 18 produces a logical 1 output signal.

If the node interface circuits 2 are not properly interconnected by the system cable 3, (i.e. not connected at either the local end or the remote end), then there is no connection between the circuit 10 and the circuit 11 via the cross-over path 12. In this case, the resistors 16a in the circuits 10 and 11, respectively, pull the inverting input terminals 23 of the comparators 13 and 25 to the supply voltage, or 24 volts. Similarly, the resistors 16b in the circuits 10 and 11, respectively, pull the non-inverting input terminals 22 of the comparators 14 and 26 to ground. Because in this configuration (e.g. not connected) the voltage at the inverting input terminals 23 at the comparators 13 and 25 (24 volts) are higher than the voltage at the non-inverting input terminals 22 (19 volts); and because the voltage at the non-inverting input terminals 22 of the comparators 14 and 26 (0 volts, e.g. ground) are less than the voltage at the inverting input terminals 23 of the comparators 14 and 26 (5 volts), the comparators 13, 25, 14 and 26 produce logical 0 signals at output terminals 18.

If the node interface circuits 2 are properly interconnected by the system cable, then the cross-over path 12 interconnects circuits 10 and 11, as illustrated in FIG. 3. In this configuration, the resistor 16a in circuit 10 and the resistor 16b in circuit 11 are coupled in series between the supply voltage terminal 15 (24 volts) and ground, and form a voltage divider. Because the values of the resistors 16a and 16b are equal, the voltage on the conductor 21 is 12 volts. Similarly, the resistor 16a in circuit 11 and the resistor 16b in circuit 10 are coupled in series between the supply voltage terminal 15 (24 volts) and ground, and form a voltage divider producing 12 volts on conductor 20. Because in this configuration (e.g. connected) the voltage on the inverting input terminals 23 of the comparators 13 and 25 (12 volts) is less than the voltage on the non-inverting input terminals 22 of the comparators 13 and 25 (19 volts); and because the voltage on the inverting input terminals 23 of the comparators 14 and 26 (5 volts) is less than the voltage on the non-inverting input terminals 22 of the comparators 14 and 26 (12 volts), the comparators 13, 25, 14 and 26 produce logical 1 signals at output terminals 18. These signals occur substantially concurrently in the circuits 10 and 11.

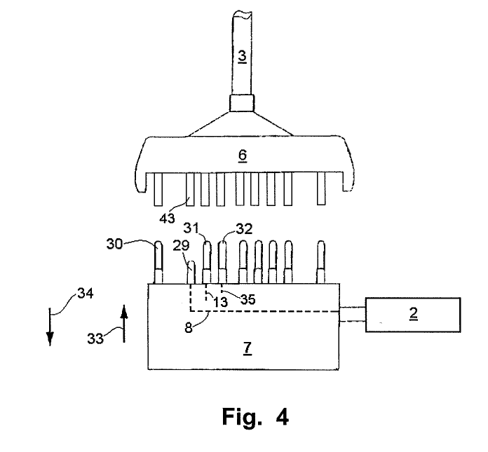

In general, the detector formed by circuits 10 and 11 generates the connection signal in response to electrical connection of staggered pins in the first and second connectors arranged so the connection signal is generated after the other pins of the first and second connectors are electrically connected. Referring to FIG. 4, the conductor 8, carrying the DockA and DockB signals, is seen to terminate at the system cable socket 7 by means of a staggered pin 29 which is shorter than the other pins 30, 31, and 32, for example, which reside in the cable socket 7. The conductor 8 is therefore the last conductor to connect when the cable plug 6 is plugged into the cable socket 7 by moving the plug 6 in the direction of arrow 34. Conductor 8 is also the first to break the electrical interconnection when the cable 3 is disconnected by moving the cable plug 6 in the direction of arrow 33.

Referring also to FIG. 2, and as described above, in the illustrated embodiment, the node interface controller 2 includes nine separate conduction paths 8, 69, 35, 36, 37, 38, 39, 40 and 41. The conduction paths, with the exception of conductor 8, terminate at cable socket 7 at a pin that is relatively longer than the staggered pin 29 (FIG. 4). For example, conductor 69, carrying power, terminates at pin 31, while conductor 35, ground, terminates at pin 32. In operation, all of the signals appearing on the conductors 69, 35, 36, 37, 38, 39, 40 and 41 are interconnected between the system cable 3 and the node interface controller 2 before the signals on conductor 8. Because power for the node interface circuit 2 is received via conductor 69 from the system cable 3, the node interface controller 2, including the dock signal interface 9 and circuit 10, is powered before the signals DockA and DockB appearing on conductor 8 are supplied to the circuit 10. More specifically, in the illustrated embodiment, a low-power power supply 53 receives power from conductor 69 and powers the node control microprocessor 42, which preferably is a low power processor before the docking signals are connected.

A time interval for power to be supplied to the circuitry and for circuit initialization to occur before the system detects that the node interface controller 2 is properly connected to the system cable 3 is, thus, provided. Thereafter, the conduction path 8 is interconnected between circuit 11 in the dock signal interface 9 in the remote node interface circuit 2 and the circuit 10 in the dock signal interface 9 in the illustrated local node interface circuit 2, via the cross-over path 12 in the system cable 3. At that time, the signal on conductor 18 reaches a logical 1 signal. This signal signals the node control microprocessor 42 that the node interface controller 2 is properly connected to a corresponding remote node interface controller 2 and a properly docked state exists. Thus, in general, a first cable interface connection is a connection between the cable 3 and an associated first device 4 in a network 1. The first interface controller 2 initiates providing power to the first device 4 in response to generation of the connection signal by circuits 10 and 11 on conductor 18, and inhibits providing power to the first device in the absence of the connection signal.

The presence of a logical 1 signal on conductor 18 is sensed by the node control microprocessor 42, which is then able to apply locally provided power and/or switch on loads (60) via signal path 19 or to control the application of system power by power controller and/or inrush current limiter 44 via signal path 43 in a controlled manner as is appropriate for that node. Waiting until the system cable 3 is completely seated prevents the formation of electrical arcing at the system connector 5, prevents transient power disturbances that could disrupt other equipment already operating within the network 1 and allows the node interface controller 2 to implement a “hot swap” or power-on functionality on a system wide level.

In a similar manner, when the system cable 3 is unplugged from a particular node interface controller 2, the staggered pin 29 (FIG. 4) disconnects before the other pins, causing a logical 0 signal on conductor 18, indicating that the system cable 3 has been, or is being disconnected, before the other pins disconnect. The logical 0 signal appearing on conductor 18 signals the node control microprocessor 42 that disconnection of the system cable 3 is imminent. The node control microprocessor 42 may then take the appropriate consequent action such as removing power from active circuitry.

The respective node interface controllers 2 are manufactured identically, except for configuration jumpers, e.g. 46, which are permanently set at the time of manufacture. As described above, the respective node interface controllers 2 may be physically integrated with their associated devices in the same enclosures. The node control microprocessor 42 in the node interface controller 2 reads the presence, absence, or position of configuration jumpers (e.g. 46) to determine the particular purpose of the node in which the node control microprocessor 42 is fabricated. The position of the jumpers (e.g. 46) permits the node control microprocessor 42 to operate in a manner that is appropriate for the particular node interface controller 2. Because the jumpers are fabricated at the time of manufacture, and are not set by installation or field personnel, they cannot be set incorrectly by such personnel.

In FIG. 2, the node interface controller 2 designated as master interface controller 70 is illustrated. As described above, the master interface controller 70 includes a dedicated link to a host computer 51 which includes a host processor 45. The host processor 45 is normally operated by or is a part of an intelligent host computer 51 which provides access to a user interface 62, and which is able to access an executable application that controls overall operation of the network 1 under the control of a user. The host processor 45 communicates with the node control microprocessor 42 via the dedicated link to receive data, and transmit data and control commands, related to the network 1. The individual interface controller 2 of the plurality of individual interface controllers 2 designated the master controller 70, has supervisory responsibility over the entire network 1 with respect to monitoring and controlling connectivity and power distribution. Other aspects of the network may be controlled by the master interface controller 70 as well.

In general, a first interface controller (i.e. master interface controller 70), automatically acquires device type identification data from a second interface controller (i.e. a node interface controller 2) monitoring a connection between a cable (i.e. the system cable 3) and an associated device (i.e. the device 4) in the network 1. The device type identification information is acquired via the system cable 3 and the first cable interface connection and the second cable interface connection at the ends of the cable. As described above, the device type identification data supports identification of the device (i.e. networked medical device 4) associated with the second cable interface controller (i.e. node interface controller 2). The first interface controller (i.e. the master controller 70) compiles a map including data indicating devices in the network and associated device type identifiers in a manner described in more detail below. More specifically, in the illustrated embodiment, the first interface controller uses the acquired device type identification data in compiling the map, and includes in the map data representing a plurality of individual devices in the network.

More specifically, the master controller 70 has supervisory responsibility over the entire network 1 with respect to monitoring and controlling connections and disconnections of nodes. The master controller 70 automatically acquires the information and device type identification data from the other node controller 2 via the system cable 3. The master interface controller 70 compiles a map 50 of the network 1 which identifies the node controllers 2 and the devices 4 connected thereto. The map includes data representing the devices 4 connected to the network.

For example, at least one node interface controller 2 may be associated with a particular type of device 4, or identified with a subset of potential operable devices 4, within a hierarchy of a plurality of node interface controllers 2 by means of at least one jumper connection (e.g. 46) that is preconfigured within at least one node interface controller 2. That is, the device type identifier data may include a priority level indicator which is integrated into the map 50 in order to create a ranking of devices in the event that the network 1 is unable to support the simultaneous operation of all of the devices 4 which may potentially be connected to the network 1. The device type identifier data may also include the power requirements of the associated device 4. The master controller 70 may initiate the acquisition of the device type identification data and the compilation of the map in response to the generation of the connection signal as described above.

The map 50 permits the master interface controller 70 to control the node controllers 2 regarding operations, such as power management and data communications, within the network 1. The master interface controller 70 communications with the host computer 51 via the dedicated link. The host computer 51 provides access to a user interface 62, and is able to access an executable application that controls overall operation of the network 1.

As described above, at least one node interface controller 2 is identified as a master interface controller 70 within a hierarchy of a plurality of interface controllers by means of at least one jumper connection (e.g. 46) that is configured within that interface controller 2. In this configuration, when the node control microprocessor 42 detects the present of that jumper connection (e.g. 46) the executable application for operating as a master controller 70 is activated. That node becomes the master controller 70. It is possible for the master controller 70 to monitor the connection of a device 4 to the system cable 3, or to be integrated with the host computer 51.

Referring again to FIG. 1, the respective node interface controllers 2 are powered by the network power supply 52 signal (scpower) on conductor 69 (FIG. 2) of the system cable 3, which typically has a nominal value of 24 volts. Whenever the system 1 has access to the network 24 volt power supply 52, the interconnected node controllers 2 are operating. The plurality of node controllers 2 operate independently of any particular medical device 4, and function even if no device 4 is present or operating. The node controllers 2 continuously monitor the network 1 for changes in network topology and communicates any changes to the master interface controller 70 which is thereby able to update the system map 50.

In general, the first interface controller (i.e. the master controller 70) uses the automatically acquired device type identification data, including the power consumption data related to the device 4 coupled to the node interface controller 2, in compiling a map 50 including data indicating a plurality of individual devices in the network and the associated power consumption of the plurality of individual devices. In general the master interface controller 70 uses the automatically acquired device type identifier data, as described above, for initiating power-on of devices 4 associated with the plurality of individual node interface controllers 2 by generating a power-on signal for communication to the plurality of individual node interface controllers 2, in response to determining the power consumption of the devices 4 associated with the plurality of individual node interface controllers 2.

More specifically, in the illustrated embodiment, the master controller 70 initially contains a previously constructed system map 50 which contains predetermined data representing the power budget for the entire network 1. The master controller 70 determines the power consumption of the devices 4 associated with the plurality of individual node interface controllers 2 from the predetermined data associating a device type with a corresponding power consumption. The master controller 70 also includes predetermined data representing the total available power in the network power supply 52. The master controller 70 compares the determined power consumption with the predetermined information indicating the total available power. The results of this comparison are used by the master controller 70 in generating power-on signals. The host computer 51 may request powering on of the network 1 and the associated devices. If the network power supply 52 reports adequate power capability, the master interface controller 70 requests activation of the network 1 by sending power-on requests to the respective node interface controllers 2 connected to the network 1. The node interface controllers 2, in turn, power on their associated devices 4.

In the event that the master interface controller 70 determines that activating the network 1 will overload the network power supply 52 connected to the network 1, based on the predicted power loads and available power resources in the map 50, it will not request activation of the network 1. Instead, the master interface controller 70 will report the potential power deficiency situation to the host computer 51 so that remedial action can be taken. For example, the first interface controller (i.e. the master controller 70) may determine that a subset of the plurality of the individual devices 4 may safely be powered-on, excluding one or more individual devices 4 from the subset, based on predetermined information indicating device priority.

Whenever an additional device 4 is connected to an already operating network 1, the node controller 2 associated with the device 4 communicates with the master interface controller 70 to obtain permission for the application of power to the particular device 4 based on the individual device type identifier. The master interface controller 70 permits the application of power to the device 4 if sufficient surplus power capacity in the network power supply 52 is available, and does not permit application of power to the device otherwise, thereby preventing an overload of the network power supply 52 by the addition of a new device 4 to the network 1.

An additional load management scheme is accomplished by a combination of the docking signals DockA and DockB, which appears on conductor 8, and the scBattDisable signal 59. The scBattDisable signal on line 59 is made available throughout the network 1 via a dedicated conductor 40 within the system cable 3. In the typical system 1, there is one system power supply (e.g. 52) which generates a positive 24 volts, and many power consuming devices 4. The power supply 52 monitors, but does not drive, the scBaftDisable signal 59.

It is possible for a dedicated power supply 60, having a larger capacity than the network power supply 52, to be connected to one of the node interface controllers 2. In that case, the larger power supply 60 connects to the power supply conductor 69 (scpower) in the system cable 3, and concurrently drives the scBattDisable signal 59 to a logical 1 signal. In response to the logical 1 scBaftDisable signal, the node interface controller 2 associated with the network power supply 52 causes the output of the system power supply 52 to be disconnected from conductor 69 (scpower) of the system cable 3 in order to prevent contention between the power supplies 52 and 60. This isolation feature is particularly advantageous when the network 1 is operating on a battery powered system supply 52 so as to prevent damaging current flow through the battery. Whenever the larger power supply 60 is disconnected from the node controller 2, as may be detected by the docking signals DockA and DockB in the manner described above, the output of the system power supply 52 is reconnected to the power supply conductor 69 (scpower) of the system cable 3, and is thus able to power the operation of the remainder of the network 1.

A point-to-point electrical signaling protocol is used for internode controller communication. For example, an asynchronous RS232 serial protocol may be utilized, or any other convenient data transfer protocol may be chosen. The interface node controllers 2 contain appropriate signal drivers 61. Typically, an isolated three wire RS232 interface cable 57 exists within the system cable 3 throughout the network 1 and is routed to the node interface controllers 2 throughout the network 1. Additional data communications capability is provided by two independent Ethernet channels 48 and 49 that are carried on conductors 39 and 41 within the system cable 3. A receive (Rx) and transmit (Tx) pair resides within the system cable 3 so as to permit identically wired system connectors 5 to be coupled.

As described above, a first interface controller 2 may be designated a master interface controller 70 and control the remainder of the plurality of individual interface controllers 2 by generating a control signal for communication to the remainder of the plurality of individual interface controllers 2 via e.g. an RS232 signal, to initiate power-on of devices 4 associated with the plurality of individual interface controllers 2. The first interface controller (i.e. master controller 70) initiates power-on of devices 4 associated with the plurality of individual interface controller 2 in response to a determination that the total power consumption of the devices 4 associated with the plurality of individual interface controllers 2 does not exceed the total available power from a network power supply 52, as determined from predetermined information, e.g. related to devices 4 and the network power supply 52, and compiled information, e.g. related to node interface controllers 2 currently connected to the system cable 3.

Variations contemplated with respect to the description of the preferred embodiment may be implemented. Any system of devices 4 which may benefit from a supervisory control network 1 that is independent of a communication network may advantageously use the principles of the present invention. The system of node controllers 2 may be used as the primary method of interconnection of networked products.

What is claimed is:

1. A system for monitoring cable interface connections in a network, an individual cable interface connection comprising a connection between a cable and an associated device in the network, comprising:
a plurality of individual interface controllers for monitoring an associated plurality of cable interface connections and including a first interface controller for automatically,
acquiring device type identification data from a second interface controller monitoring a connection between a cable and an associated device in the network, said device type identification data being acquired via said cable and first and second cable interface connections at the ends of said cable, said device type identification data supporting identification of said device associated with said second cable interface connection, and
compiling a map comprising data indicating devices in said network and associated device type identifiers.

2. The system according to claim 1, including a detector for generating a connection signal in response to detecting first and second ends of said cable are electrically connected to corresponding first and second connectors of said first and second cable interface connections.

3. The system according to claim 2, wherein said detector generates said connection signal in response to detection of a valid electrical connection through said cable and between first and second circuits associated with respective first and second cable interface connections.

4. The system according to claim 2, wherein said detector generates a connection signal in response to electrical connection of staggered pins in said first and second connectors arranged so said connection signal is generated after the other pins of said first and second connectors are electrically connected.

5. The system according to claim 2, wherein said first interface controller initiates said acquiring said device type identification data and compiling said map in response to generation of said connection signal.

6. The system according to claim 2, wherein
said first cable interface connection comprises a connection between said cable and an associated first device in the network; and
said first interface controller initiates providing power to said first device in response to generation of said connection signal and inhibits providing power to said first device in the absence of said connection signal.

7. The system according to claim 1, wherein said first interface controller compiles a map comprising data indicating a plurality of individual devices and associated power consumption of said plurality of individual devices.

8. The system according to claim 7, wherein said first interface controller uses a device type identifier to derive a power consumption of an associated individual device from predetermined data associating a device type with a corresponding power consumption.

9. The system according to claim 7, wherein said first interface controller determines whether there is sufficient available power to enable said device to be powered-on from predetermined information indicating total available power and a total power consumption of said plurality of individual devices.

10. The system according to claim 9, wherein said first interface controller determines a subset of said plurality of said individual devices are to be powered-on excluding one or more individual devices from said subset based on predetermined information indicating device priority.

11. The system according to claim 1, wherein said first interface controller is a master interface controller for controlling the remainder of said plurality of individual interface controllers by generating a control signal for communication to said remainder of said plurality of individual interface controllers to initiate power-on of devices associated with said plurality of individual interface controllers.

12. The system according to claim 11, wherein said first interface controller initiates power-on of devices associated with said plurality of individual interface controllers in response to a determination a total power consumption of said devices associated with said plurality of individual interface controllers does not exceed total available power as determined from predetermined information and compiled information.

13. The system according to claim 12, wherein at least one interface controller is identified within a hierarchy of a plurality of interface controllers by means of at least one jumper connection that is configured within the interface controller.

14. The system according to claim 12, wherein at least one interface controller is associated with a particular type of device within a hierarchy of a plurality of interface controllers by means of at least one jumper connection that is configured within the interface controller.

15. The system according to claim 12, wherein at least one interface controller is identified with a subset of potential operable devices within a hierarchy of a plurality of interface controllers by means of at least one jumper connection that is configured within at least one interface controller.

16. A system for monitoring cable interface connections in a network, an individual cable interface connection comprising a connection between a cable and an associated device in the network, comprising:
a plurality of individual interface controllers for monitoring an associated plurality of cable interface connections and including a first interface controller for automatically:
acquiring device type identification data from a second interface controller monitoring a connection between a cable and an associated device in the network, said device type identification data being acquired via said cable and first and second cable interface connections at the ends of said cable, said device type identification data supporting identification of said device associated with said second cable interface connection, and
using said acquired device type identification data in compiling a map comprising data indicating a plurality of individual devices in said network and associated power consumption of said plurality of individual devices.

17. The system according to claim 16, wherein said first interface controller uses said acquired device type identification data in compiling said map by deriving a power consumption of an associated individual device from predetermined data associating a device type with a corresponding power consumption.

18. A system for monitoring cable interface connections in a network, an individual cable interface connection comprising a connection between a cable and an associated device in the network, comprising:
a plurality of individual interface controllers for monitoring an asosociated plurality of cable interface connections and including a master interface controller for automatically:
acquiring device type identification data from a node interface controller monitoring a connection between a cable and an associated device in the network, said device type identification data being acquired via said cable and first and second cable interface connections at the ends of said cable, said device type identification data supporting identification of said device associated with said second cable interface connection, and
using said acquired device type identifier for initiating power-on of devices associated with a plurality of individual node interface controllers by generating a power-on signal for communication to said plurality of individual node interface controllers, in response to determining power consumption of said devices associated with said plurality of individual node interface controllers.

19. The system according to claim 18, wherein
said master interface controller determines power consumption of said devices associated with said plurality of individual node interface controllers from predetermined data associating a device type with a corresponding power consumption, and compares said determined power consumption with predetermined information indicating total available power in generating said power-on signal.

20. The system according to claim 19, wherein at least one interface controller is identified as the master interface controller within a hierarchy of a plurality of interface controllers by means of at least one jumper connection that is configured within the interface controller.
